(19) United States
(12) Patent Application Publication
(10) Pub. No.: US 2005/0011924 A1
(43) Pub. Date: Jan. 20, 2005

(54) Machining apparatus for forming cracking slot for connecting rod

(76) Inventors: Yasuo Momose, Utsunomiya-shi (JP); Sigeo Ota, Tochigi-ken (JP)

Correspondence Address: BIRCH STEWART KOLASCH & BIRCH, PO BOX 747, FALLS CHURCH, VA, 22040-0747, US

(21) Appl. No.: 10/890,130

(22) Filed: Jul. 14, 2004

(30) Foreign Application Priority Data
Jul. 15, 2003 (JP) 2003-274822

(51) Int. Cl. B26F 3/00; B65H 35/00

(52) U.S. Cl. 225/1; 225/103

(57) ABSTRACT

When a rotary drive source on a body is energized, a drive pulley is rotated, and the rotary drive power from the drive pulley is transmitted to a driven pulley by a drive power transmitting belt. A slotting mechanism integrally coupled to the driven pulley is rotated and inserted into a larger end hole defined in a connecting rod. A cutter of the slotting mechanism forms a first slot having a substantially V-shaped cross section in the inner circumferential surface of the larger end hole and then a second slot having a substantially V-shaped cross section in the inner circumferential surface of the larger end hole at a position facing the first slot across the axis of the connecting rod. The first and second slots have a symmetrical shape.

### BACKGROUND OF THE INVENTION

1. Field of the Invention

The present invention relates to a machining apparatus for forming a cracking slot in an inner surface of a larger end hole defined in an integral connecting rod for use in a vehicular engine, the cracking slot being used to break the one-piece connecting rod into a cap and a rod.

2. Description of the Related Art

Vehicular engines have a crankshaft operatively coupled to pistons by connecting rods for transmitting rotational drive power from the crankshaft to the pistons.

Each of the connecting rods has a larger end hole defined in a larger end thereof, and a journal of the crankshaft is rotatably supported in the larger end hole by a bearing mounted in the larger end hole. The connecting rod also has a smaller end hole defined in a smaller end thereof. A piston pin extending through a piston is inserted and supported in the smaller end hole by another bearing.

The connecting rod is generally formed by forging. There are known two processes for forming the connecting rod. According to one process, a shank serving as a main connecting rod body and a cap are separately produced. According to the other process, which is known as a cracking process, a one-piece connecting rod is produced and then fractured into a shank and a cap.

In the cracking process, for fracturing the one-piece connecting rod into the shank and the cap, a pair of cracking slots is formed in the boundary between the shank and the cap on the inner surface of a larger end hole which is formed in a larger end of the connecting rod. The slots are formed to a predetermined depth by broaching or laser beam machining when or after the one-piece connecting rod is produced.

Then, a pressurizing hose is inserted in the larger end hole in the connecting rod, and a pressurizing liquid is supplied to the pressurizing hose to expand the pressurizing hose radially outwardly, pressing the inner surface of the larger end hole radially outwardly. The larger end of the connecting rod is now caused to crack from the slots, fracturing the connecting rod into a shank and a cap (see, for example, Japanese laid-open patent publication No. 11-245122).

Generally, for fracturing the connecting rod uniformly and smoothly into the shank and the cap, it is necessary that the cracking slots formed in the inner surface of the larger end hole be substantially uniform in position and depth, i.e., the cracking slots be symmetrical in shape.

If the cracking slots are formed by broaching, then since the cutting tool or broach has a substantially circular cross-sectional shape, the cracking slots are of a substantially semicircular cross-sectional shape extending from the inner surface of the larger end hole. However, it is difficult to fracture the connecting rod into the shank and the cap reliably and uniformly when the cracking slots are of a substantially semicircular cross-sectional shape.

On the other hand, if the cracking slots are formed by laser beam machining, then since a case-hardened layer is developed in the inner surface of the larger end hole near the cracking slots, the mechanical strength of the connecting rod tends to be adversely affected by the material change in the vicinity of the larger end hole. In addition, debris such as sludge produced when the cracking slots are formed is applied to the inner surface of the larger end hole.

Another problem that occurs when broached or laser-beam-machined cracking slots are formed on the larger end hole is that it is complex and highly costly to change the shape or depth of the cracking slots.

### SUMMARY OF THE INVENTION

It is a general object of the present invention to provide a machining apparatus for reliably and inexpensively forming sharp cracking slots in the inner surface of a larger end hole defined in a connecting rod.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view, partly cut away, of a machining apparatus for forming cracking slots for a connecting rod according to a first embodiment of the present invention;

FIG. 2 is a front elevational view, partly in cross section, of the machining apparatus shown in FIG. 1;

FIG. 3 is a side elevational view, partly in cross section, of the machining apparatus shown in FIG. 1;

FIG. 4 a plan view, partly in cross section, of a slotting mechanism of the machining apparatus shown in FIG. 1 and a larger end of a connecting rod;

FIG. 5 is an enlarged vertical cross-sectional view showing the manner in which the slotting mechanism is inserted in a larger end hole of the connecting rod and is producing a first slot in the inner circumferential surface of the larger end hole;

FIG. 6 is an enlarged vertical cross-sectional view showing the manner in which the slotting mechanism shown in FIG. 5 is displaced downwardly through the larger end hole after having produced the first slot;

FIG. 7 is an enlarged vertical cross-sectional view showing the manner in which the slotting mechanism shown in FIG. 6 is displaced upwardly into the larger end hole and is producing a second slot in the inner circumferential surface of the larger end hole at a position diametrically opposite to the first slot;

FIG. 8 is an enlarged fragmentary plan view of the machining apparatus shown in FIG. 4 near the first slot or the second slot;

FIG. 9A is a perspective view of the connecting rod with the first and second slots formed therein;

FIG. 9B is a perspective view of the connecting rod which is fractured into a cap and a rod;

FIG. 10 is a front elevational view, partly in cross section, of a machining apparatus for forming cracking slots for a connecting rod according to a second embodiment of the present invention;

FIG. 11 is a side elevational view, partly in cross section, of the machining apparatus shown in FIG. 10; and

FIG. 12 is an enlarged vertical cross-sectional view of a modified slotting mechanism having roller bearings which are used in place of ball bearings in the machining apparatus shown in FIG. 11.

### DESCRIPTION OF THE PREFERRED EMBODIMENTS

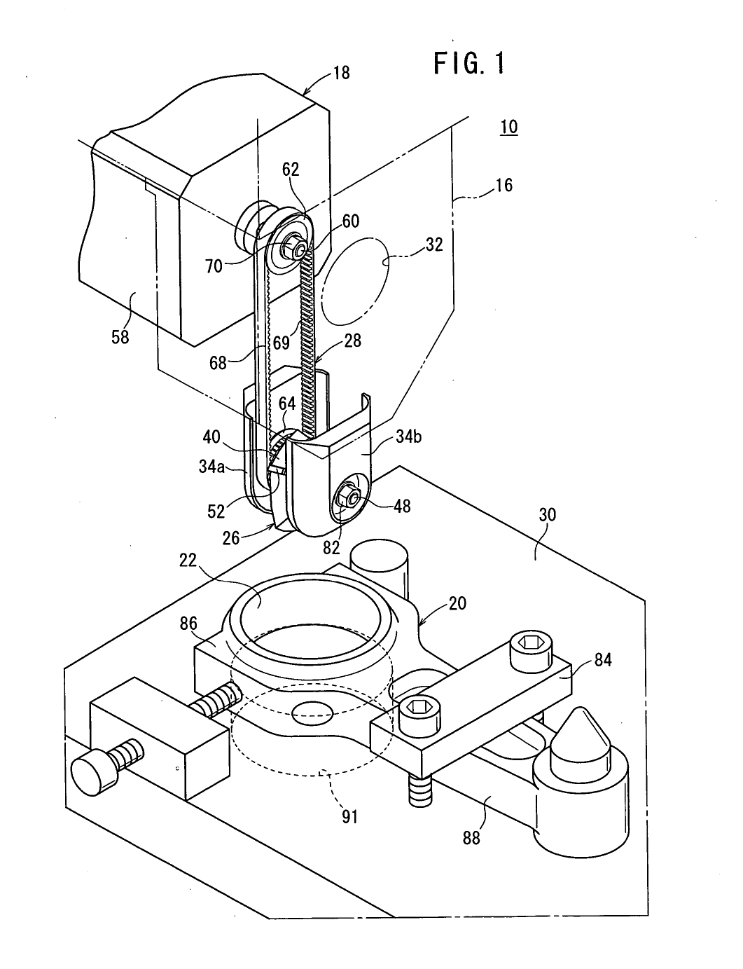

FIGS. 1 through 3 show a machining apparatus 10 for forming cracking slots for a connecting rod according to a first embodiment of the present invention.

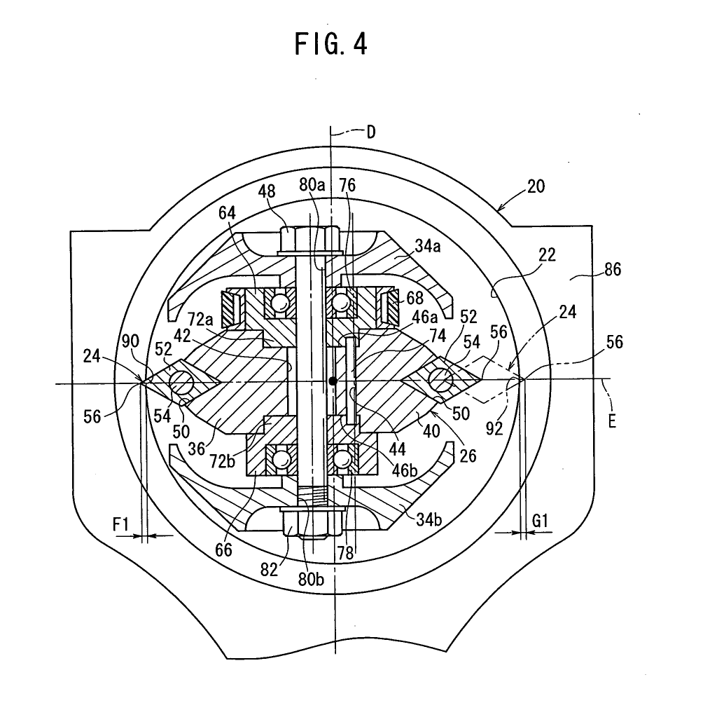

The machining apparatus 10 has a body 16 coupled by bolts or the like (not shown) to an end of an industrial articulated robot 12 (e.g., a numerically controlled machine), and an actuator 18 coupled to the body 16 and rotatable by an electric signal applied thereto. The machining apparatus 10 also has a slotting mechanism (rotary cutter) 26 mounted on the lower end of the body 16 for forming cracking slots 24 (see FIG. 4) in the inner circumferential surface of a larger end hole 22 in a connecting rod 20, and a drive power transmitting mechanism 28 for transmitting rotational drive power from the actuator 18 to the slotting mechanism 26.

A workpiece table 30 with the connecting rod 20 positioned and fixedly mounted thereon is disposed below the machining apparatus 10.

When the robot 12 operates, the machining apparatus 10 integrally coupled to the robot 12 is movable in any desired direction to any desired position in a three-dimensional space represented by three X, Y, Z axes.

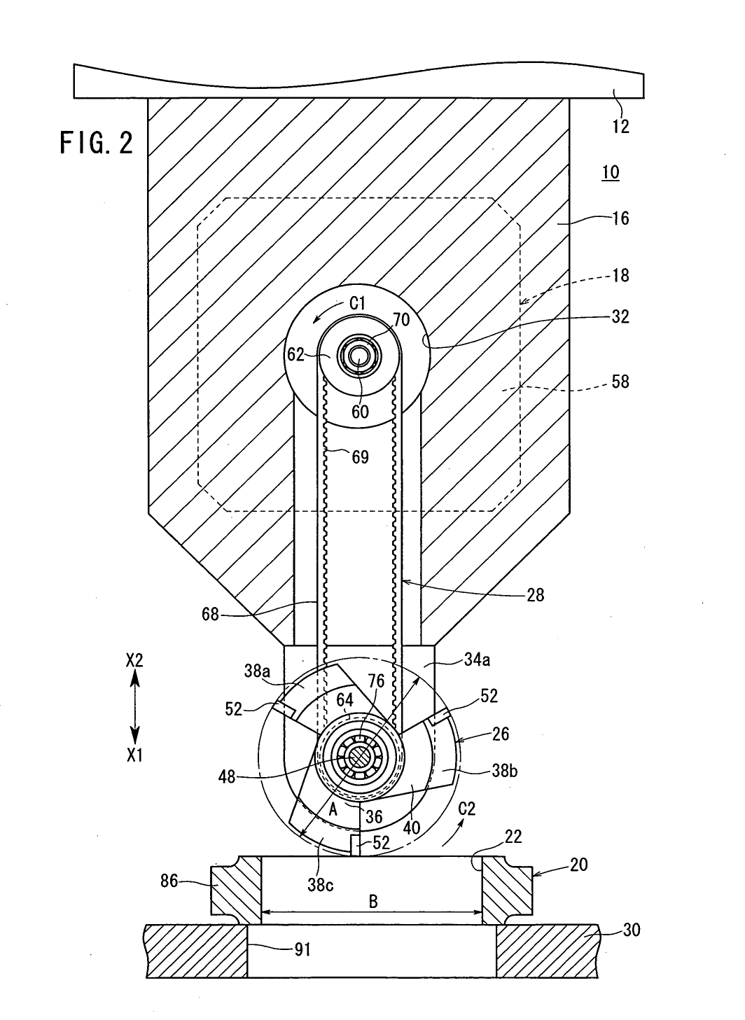

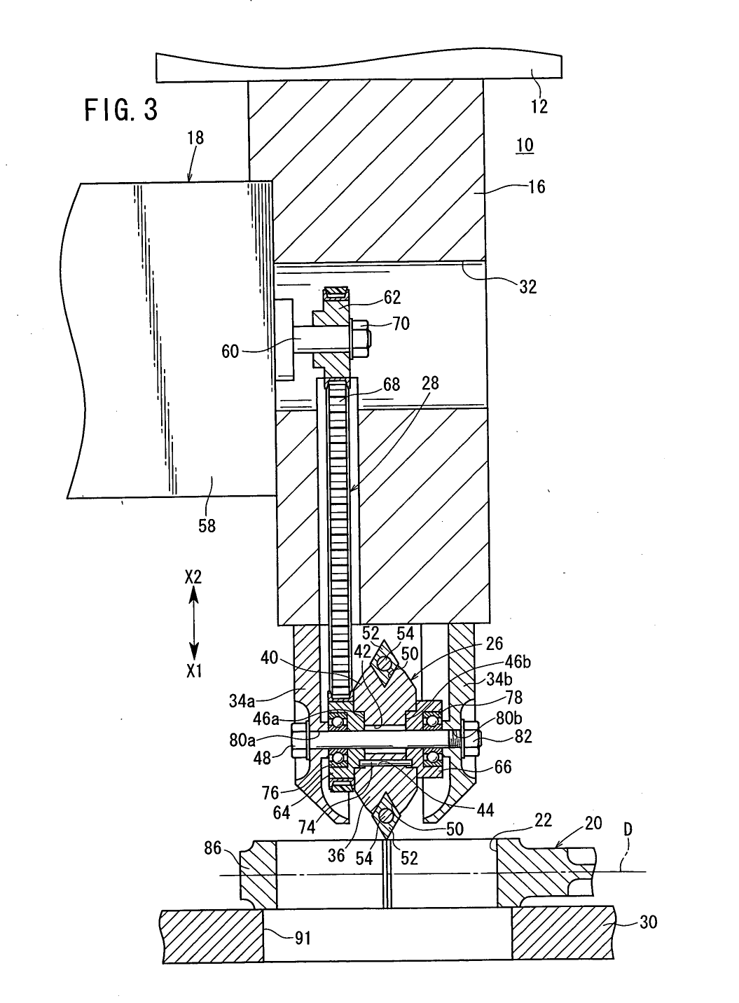

As shown in FIGS. 2 and 3, the body 16 has a substantially circular opening 32 defined substantially centrally therein at a position facing a drive pulley (first pulley) 62, to be described later on, disposed in the body 16. The opening 32 is larger in diameter than the drive pulley 62, which can thus be removed out of the body 16 through the opening 32.

The slotting mechanism 26 is rotatably supported by a pair of support legs 34a, 34b (see FIG. 3) projecting downwardly from a lower surface of the body 16.

As shown in FIGS. 3 and 4, the slotting mechanism 26 comprises a cutter (rotary member) 40 having three plates 38a through 38b projecting radially outwardly from a substantially central wheel-shaped main body 36.

The wheel-shaped main body 36 has an axial through hole 42 defined substantially centrally therein, and also has a pin hole 44 defined therein substantially parallel to the axial through hole 42 and spaced a predetermined distance radially outwardly from the axial through hole 42. The wheel-shaped main body 36 also has a first recess 46a and a second recess 46b which are defined in respective opposite side surfaces thereof. The first and second recesses 46a, 46b are greater in diameter than the axial through hole 42 and have a predetermined depth from the respective opposite side surfaces of the cutter 40. The first and second recesses 46a, 46b communicate with the axial through hole 42 and also communicate with each other through the pin hole 44. A support bolt (rotational shaft) 48 is inserted through a hole 80a defined in one of the support legs 34a, extends through the axial through hole 42 in the wheel-shaped main body 36, and is inserted through a hole 80b defined in the other support leg 34b. A nut 82 is threaded over the externally threaded end of the support bolt 48, supporting the cutter 40 rotatably on the support legs 34a, 34b.

As shown in FIG. 2, the plates 38a through 38c are angularly equally spaced around the main body 36 and have respective arcuate outer circumferential surfaces. The outer circumferential surfaces of the plates 38a through 38c have substantially the same diameter. Cutting tips 52 made of cemented carbide are mounted in respective mounting grooves 50 (see FIGS. 3 and 4) defined to a predetermined depth in side surfaces of the plates 38a through 38c which extend from the outer circumferential surfaces thereof toward the center of the main body 36. Specifically, the cutting tips 52 are fastened to the respective plates 38a through 38c by bolts 54 (see also FIG. 1).

The number of the plates 38a through 38c is not limited to 3, but may be of any value insofar as they project radially outwardly from the main body 36 and angularly spaced at substantially equal angular intervals.

As shown in FIG. 4, each of the cutting tips 52 is of a substantially diamond-shaped cross section and has a sharp cutting edge 56 on its distal end. The cutting edge 56 has its tip end (crest) slightly rounded at a radius ranging from 0.1 to 0.2 mm. The cutting tips 52 are mounted in place with their cutting edges 56 projecting radially outwardly slightly from the outer circumferential surfaces of the plates 38a through 38c. The distances that the cutting edges 56 project from the outer circumferential surfaces of the plates 38a through 38c are substantially the same as each other on the plates 38a through 38c.

Stated otherwise, the outer circumferential surfaces of the plates 38a through 38c are of substantially the same diameter, and the cutting edges 56 of the cutting tips 52 mounted on the respective plates 38a through 38c have substantially the same maximum outer circumferential diameters. The cutting tips 52 mounted on the respective plates 38a through 38c are of substantially the same shapes.

Since the cutting edges 56 of the cutting tips 52 have their tip ends slightly rounded, the contact resistance that is developed between the cutting tips 52 and the connecting rod 20 is reduced at the time the first and second slots 90, 92 are formed in the larger end hole 22 in the connecting rod 20. As a result, the load on the cutting tips 52 is reduced, thus increasing the service life of the cutting tips 52.

As shown in FIG. 2, the diameter A of a circular path which is followed by the cutting edges 56 of the cutting tips 52 when the cutter 40 rotates is smaller than the diameter B of the larger end hole 22 in the connecting rod 20 (A<B).

The actuator 18 comprises a rotary drive source 58 (e.g., a motor) coupled to a substantially central area of the body 16, and has a drive shaft 60 which can be rotated counterclockwise in the direction indicated by the arrow C1 when an electric signal is applied to the rotary drive source 58. As shown in FIG. 3, the rotary drive source 58 is connected to a side surface of the body 16 surrounding the opening 32, and the drive shaft 60 is inserted into the opening 32 in the body 16.

The drive power transmitting mechanism 28 comprises a drive pulley 62 mounted on the drive shaft 60 of the rotary drive source 58, a driven pulley (second pulley) 64 integrally coupled to a side of the cutter 40 of the slotting mechanism 26, a rotor 66 coupled to an opposite side of the cutter 40 axially remotely from the driven pulley 64, and a drive power transmitting belt 68 trained around the drive pulley 62 and the driven pulley 64.

The drive pulley 62 is integrally mounted on the drive shaft 60 by a nut 70 in the opening 32 for rotation with the drive shaft 60 at the time the rotary drive source 58 is actuated.

As shown in FIG. 4, the driven pulley 64 has an engaging land 72a formed on one side thereof and inserted in the first recess 46a of the cutter 40. An engaging pin 74 has an end inserted in the engaging land 72a and extends through the pin hole 44. The driven pulley 64 houses therein a first bearing 76 which is positioned coaxially with the driven pulley 64.

The rotor 66 that is coupled to the opposite side of the cutter 40 axially remotely from the driven pulley 64 is of substantially the same shape as the driven pulley 64. The rotor 66 has an engaging land 72b formed on one side thereof and inserted in the second recess 46b of the cutter 40. The engaging pin 74 which extends through the pin hole 44 has an opposite end inserted in the engaging land 72b. The rotor 66 houses therein a second bearing 78 which is positioned coaxially with the rotor 66.

That is, the engaging lands 72a, 72b of the driven pulley 64 and the rotor 66 are inserted respectively in the first and second recesses 46a, 46b of the cutter 40, and the engaging pin 74 which engages the engaging lands 72a, 72b extends through the pin hole 44. Therefore, the driven pulley 64 and the rotor 66 are prevented from being angularly displaced with respect to the cutter 40, but are rotatable in unison with the cutter 40.

The support bolt 48 extends through the first bearing 76 housed in the driven pulley 64 and the second bearing 78 housed in the rotor 66. Therefore, the driven pulley 64 and the rotor 66 are rotatably supported by the support bolt 48.

Stated otherwise, the support bolt 48 is inserted through a hole 80a defined in the support leg 34a, then through the first bearing 76 in the driven pulley 64, the through hole 42 in the cutter 40, and the second bearing 78 in the rotor 66. The externally threaded end of the support bolt 48 is inserted through the hole 80b in the other support leg 34b, and the nut 82 is threaded over the externally threaded end of the support bolt 48.

Since the driven pulley 64 and the rotor 66 have their respective engaging lands 72a, 72b inserted respectively in the first and second recesses 46a, 46b with the engaging pins 74 engaging the engaging lands 72a, 72b and extending through the pin hole 44, the cutter 40 is rotatable in unison with the driven pulley 64 and the rotor 66 with respect to the support legs 34a, 34b.

As shown in FIG. 2, the drive power transmitting belt 68 is trained around the drive pulley 62 mounted on the drive shaft 60 of the rotary drive source 58 and the driven pulley 64 mounted on the cutter 40, and extends in the body 16. The drive power transmitting belt 68 has a plurality of parallel spaced teeth 69 held in mesh with the teeth of the drive pulley 62 and the driven pulley 64 for providing circulatory motion around the drive pulley 62 and the driven pulley 64. When the drive shaft 60 of the rotary drive source 58 rotates, the drive power from the drive pulley 62 is transmitted by the drive power transmitting belt 68 to the driven pulley 64, which rotates the cutter 40 therewith.

The workpiece table 30 disposed below the machining apparatus 10 is mounted on a floor or the like (not shown), and has an upper surface lying substantially horizontally. The connecting rod 20 is placed on the upper surface of the workpiece table 30 so as to have its axis D (see FIG. 3) extending substantially parallel to the upper surface of the workpiece table 30. The connecting rod 20 has its substantially central region fixed to the workpiece table 30 by a fastening member 84 (see FIG. 1).

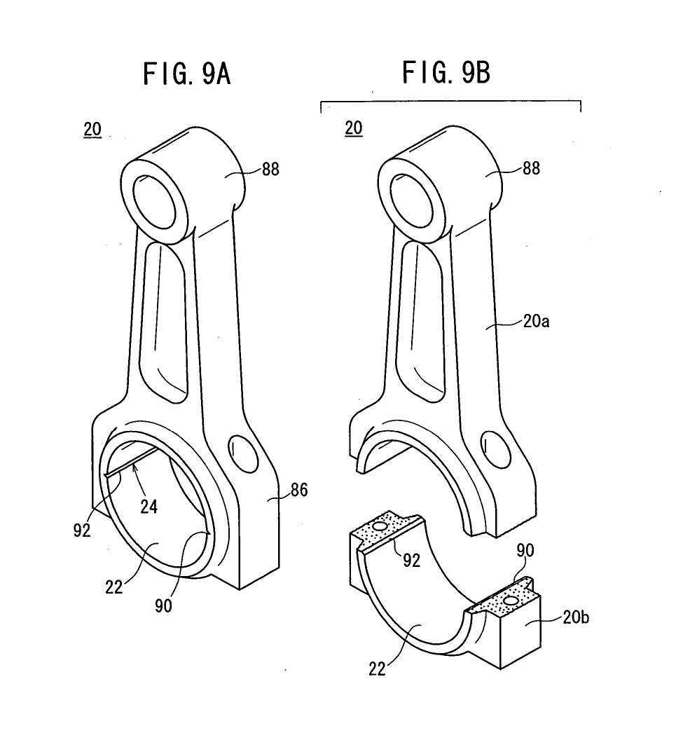

As shown in FIG. 9A, the connecting rod 20 comprises a larger end 86 having a larger width and a smaller end 88 having a smaller width opposite to the larger end 86. The larger end hole 22 is defined in the larger end 86 for insertion therein a journal of a crankshaft (not shown).

The machining apparatus 10 for forming cracking slots for a connecting rod according to the first embodiment of the present invention is basically constructed as described above. Operation and advantages of the machining apparatus 10 will be described below. The position shown in FIG. 1, in which the connecting rod 20 where the cracking slots 24 (see FIG. 4) are to be formed is fastened to the upper surface of the workpiece table 30 by the fastening member 84 and the machining apparatus 10 is positioned above the connecting rod 20, will be referred to as an initial position.

As shown in FIG. 4, the first and second slots 90, 92 are to be formed as the cracking slots 24 in the inner circumferential surface of the larger end hole 22 in the connecting rod 20 at respective positions which are traversed by a base line E that passes through the center of the larger end hole 22 and extends substantially perpendicularly to the axis D of the connecting rod 20.

First, the smaller end 88 of the connecting rod 20 is placed on the upper surface of the workpiece table 30 at a lower position (see FIG. 1) and the larger end 86 of the connecting rod 20 is placed on the upper surface of the workpiece table 30 at an upper position (see FIG. 1). For forming the first slot 90 in the inner circumferential surface of the larger end hole 22 in the connecting rod 20 at a position which is on the left-hand side of the axis D (see FIG. 4), the machining apparatus 10 positioned above the connecting rod 20 is moved by the robot 12 to position the cutter 40 above the larger end hole 22. Then, the machining apparatus 10 is moved to a position where the center of the cutter 40 is offset leftward from the axis D of the connecting rod 20 and the outer circumferential diameters A of the cutting edges 56 of the cutting tips 52 overlap the inner circumferential diameter of the larger end hole 22 radially outwardly by a distance F1 (see FIG. 4).

The outer circumferential diameters A of the cutting edges 56 referred to above represent a circular path that is followed by the outer circumferential surfaces of the cutting edges 56 at the time the cutter 40 rotates (see FIG. 2).

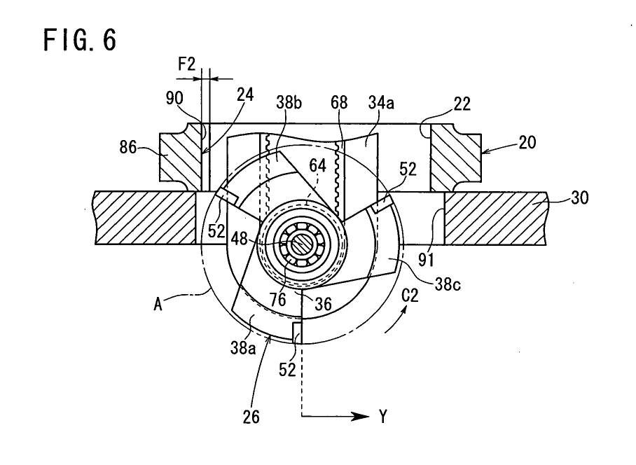

Stated otherwise, the distance F1 by which the outer circumferential diameters A of the cutting edges 56 overlap the inner circumferential diameter of the larger end hole 22 radially outwardly represents the depth F2 (see FIG. 6) of the first slot 90 to be formed by the cutter 40 (F1=F2) Then, as shown in FIG. 2, with the machining apparatus 10 positioned above the larger diameter hole 22 in the connecting rod 20, an electric signal is applied to the rotary drive source 58 to rotate the drive shaft 60 thereof counterclockwise in the direction indicated by the arrow C1, rotating the drive pulley 62 counterclockwise in unison with the drive shaft 60. When the drive pulley 62 is rotated, the drive power transmitting belt 68 causes the drive pulley 64 to rotate counterclockwise in the direction indicated by the arrow C2, so that the drive pulley 62 and the driven pulley 64 rotate in the same direction at the same rotational speed.

Therefore, the cutter 40 integrally coupled to the driven pulley 62 is rotated about the support bolt 48 counterclockwise in the direction indicated by the arrow C2.

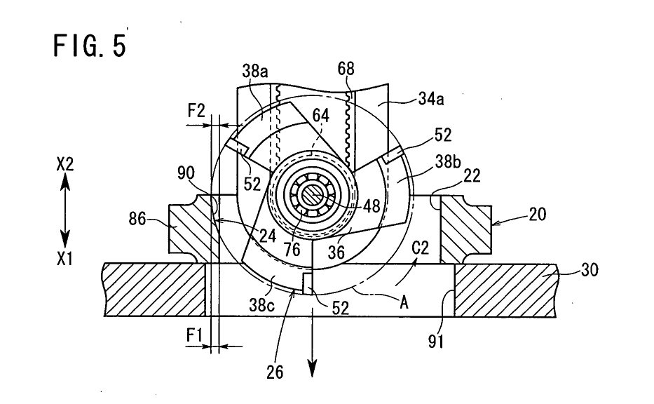

While the cutter 40 is rotating, the robot 12 displaces the machining apparatus 10 downwardly in the direction indicated by the arrow X1 to insert the cutter 40 gradually into the larger end hole 22. Since the tip ends of the cutting edges 56 of the cutter 40 overlap the inner circumferential surface of the larger end hole 22 radially outwardly, the cutting edges 56 of the cutting tips 52 made of cemented carbide contact and cut off the inner circumferential surface of the larger end hole 22 while the cutter 40 is rotating and being displaced downwardly. Specifically, the cutting edges 56 are gradually displaced downwardly while scraping off the inner circumferential surface of the larger end hole 22 (see FIG. 5).

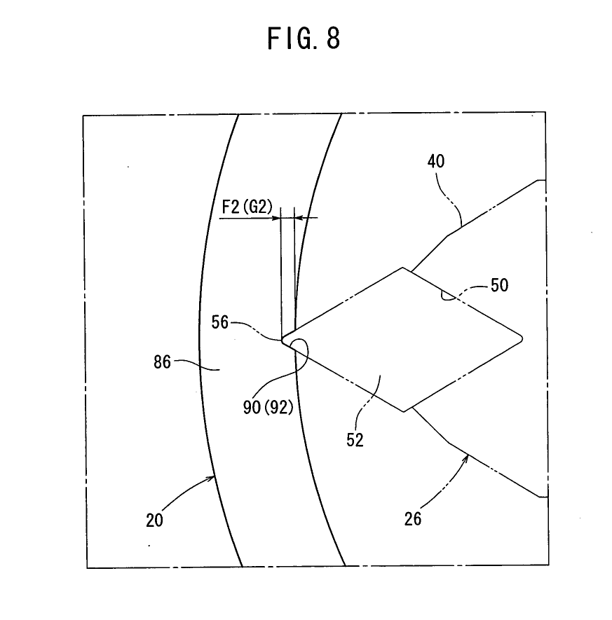

Inasmuch as the outer circumferential diameters A of the cutting edges 56 are substantially the same as each other, the circular paths followed by the respective cutting tips 52 as they rotate are of substantially the same diameter. When the cutter 40 is displaced while rotating substantially vertically downwardly in the direction indicated by the arrow X1 toward the upper surface of the workpiece table 30, the cutter 40 produces the first slot 90 of constant width in a left surface area of the inner circumferential surface of the larger end hole 22. The first slot 90 functions as one of the cracking slots 24, and is formed linearly in a direction substantially perpendicular to the axis D of the connecting rod 20. The first slot 90 has a sharp, substantially V-shaped cross section (see FIG. 8) having a depth F2.

After the first slot 90 is formed in the inner circumferential surface of the larger end hole 22, the cutter 40 is brought into a position below the connecting rod 20 through the larger end hole 22 and a cutter clearance hole 91 that is defined substantially centrally in the workpiece table 30 (see FIG. 6). The cutter clearance hole 91 is of a diameter greater than the larger end hole 22. Therefore, the cutter 40 does not contact the inner circumferential surface of the cutter clearance hole 91 when the cutter 40 moves into the cutter clearance hole 91.

At this time, the cutter 40 is still rotating counterclockwise in the direction indicated by the arrow C2 because of continued operation of the rotary drive source 58.

Then, the second slot 92 is formed on the inner circumferential surface of the larger end hole 22 at a position diametrically opposite to the first slot 90 across the axis D (see FIG. 4) of the connecting rod 20.

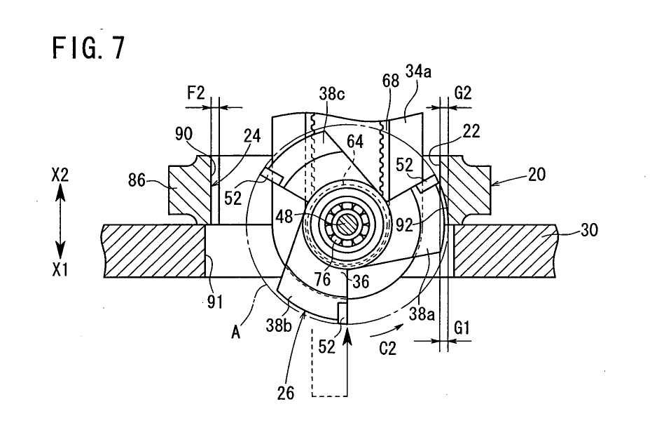

First, as shown in FIG. 6, the machining apparatus 10 whose cutter 40 is displaced downwardly of the connecting rod 20 is moved by the robot 12 to displace the cutting edges 56 of the cutter 40 substantially horizontally in the direction indicated by the arrow Y toward a right surface area of the inner circumferential surface of the larger end hole 22 which faces the first slot 90. The machining apparatus 10 is moved until the outer circumferential diameters of the cutting edges 56 overlap the right surface area of the inner circumferential surface of the larger end hole 22 which faces the first slot 90, radially outwardly by a predetermined distance G1 (see FIG. 7).

Stated otherwise, the distance G1 by which the outer circumferential diameters of the cutting edges 56 overlap the right surface area of the inner circumferential surface of the larger end hole 22 represents a depth G2 (see FIG. 7) of the second slot 92 to be formed by the cutter 40. The overlapping distance G1 is the same as the overlapping distance F1 by which the cutting edges 56 overlap the left surface area of the inner circumferential surface of the larger end hole 22 to form the first slot 90 (F1=G1). As a consequence, the depth of the first slot 90 and the depth of the second slot 92 are the same (F2=G2).

After having formed the first slot 90, the machining apparatus 10 is displaced downwardly of the connecting rod 20 and then moved substantially horizontally in the direction indicated by the arrow Y. Therefore, the cutter 40 is displaced along the base line E (see FIG. 4) in and across the larger end hole 22, with the machining apparatus 10 moved to a position which faces the first slot 90 across the axis D of the connecting rod 20.

Then, under the control of the robot 12, the machining apparatus 10 is gradually displaced vertically upwardly in the direction indicated by the arrow X2 from the position below the larger end hole 22. The cutter 40 is now gradually inserted upwardly into the larger end hole 22. Since the tip ends of the cutting edges 56 of the cutter 40 overlap the inner circumferential surface of the larger end hole 22 radially outwardly, the cutting edges 56 of the cutting tips 52 made of cemented carbide contact and cut off the inner circumferential surface of the larger end hole 22 while the cutter 40 is rotating and being displaced upwardly. Specifically, the cutting edges 56 are gradually displaced upwardly while scraping off the inner circumferential surface of the larger end hole 22 (see FIG. 7).

Because the outer circumferential diameters A of the cutting tips 52 are substantially the same as each other, the circular paths followed by the respective cutting tips 52 when they are rotated are substantially the same as each other. Since the cutter 40 as it rotates is displaced substantially vertically upwardly in the direction indicated by the arrow X2 with respect to the upper surface of the workpiece table 30, the cutter 40 forms the second slot 92 in the inner circumferential surface of the larger end hole 22 to a depth that is substantially equal to the depth of the first slot 90.

As shown in FIG. 4, the second slot 92 is formed in the inner circumferential surface of the larger end hole 22 at a position diametrically opposite to the first slot 90 across the axis D of the connecting rod 20, and has the same depth as the first slot 90 (F2=G2) (see FIG. 7). The second slot 92 functions as the other of the cracking slots 24 and is formed linearly in a direction substantially perpendicular to the axis D of the connecting rod 20. The second slot 92 has a sharp, substantially V-shaped cross section (see FIG. 8).

Finally, after the cutter 40 is displaced upwardly through the larger end hole 22, it reaches the initial position above the connecting rod 20 (see FIG. 2). As a consequence, the cracking slots 24 in the form of the first and second slots 90, 92 are formed in the inner circumferential surface of the larger end hole 22 in the connecting rod 20 fixed to the upper surface of the workpiece table 30, the cracking slots 24 being symmetrically positioned and shaped with respect to the axis D of the connecting rod 20 and having the same depth as each other.

According to the first embodiment, as described above, the slotting mechanism 26 is rotated by the drive power transmitting belt 68 upon rotation of the rotary drive source 58, and the cutter 40 of the slotting mechanism 26 is inserted into the larger end hole 22 in the connecting rod 20 to cause the cutting tips 52 of the cutter 40 to form the first and second slots 90, 92 as the cracking slots 24 of substantially V-shaped cross section in the inner circumferential surface of the larger end hole 22.

Subsequently, a fracturing jig (not shown) is inserted into the larger end hole 22, and pressed radially outwardly against the inner circumferential surface of the larger end hole 22. Under the pressure imposed by the fracturing jig, the connecting rod 20 starts being fractured from the cracking slots 24 reliably and highly accurately into a rod 20a and a cap 20b (see FIG. 9B).

The drive pulley 62 which is rotated by the rotary drive source 58 and the driven pulley 64 integrally coupled to the slotting mechanism 26 for forming the first and second slots 90, 92 in the inner circumferential surface of the larger end hole 22 are offset from the axis of the machining apparatus 10, and the drive power is transmitted from the drive pulley 62 through the drive power transmitting belt 68 to the driven pulley 64. The slotting mechanism 26 for forming the first and second slots 90, 92 is relatively small in size and can easily be inserted and rotated in the larger end hole 22.

As a result, the cracking slots 24 in the form of the first and second slots 90, 92 can appropriately be formed in the inner circumferential surface of the larger end hole 22 by the cutter 40 of the slotting mechanism 26.

The robot 12 for moving the machining apparatus 10 may comprise a numerically controlled machine, for example, for programming a position to which the machining apparatus 10 is to move and controlling the machining apparatus 10 highly accurately to move to the programmed position. Therefore, the positions and depths of the first and second slots 90, 92 in the larger end hole 22 can be controlled easily and highly accurately. Consequently, the first and second slots 90, 92 can be formed in the larger end hole 22 to the same depth at symmetrical positions with respect to the axis D of the connecting rod 20.

Inasmuch as the tip ends of the cutting edges 56 of the cutting tips 52 are slightly rounded, the contact resistance that is developed between the cutting tips 52 and the connecting rod 20 is reduced at the time the first and second slots 90, 92 are formed in the larger end hole 22 in the connecting rod 20. As a result, the load on the cutting tips 52 is reduced, thus increasing the service life of the cutting tips 52.

In addition, the machining apparatus 10 is less costly than facilities for forming slots in the larger end hole 22 according to the conventional broaching or laser beam machining process.

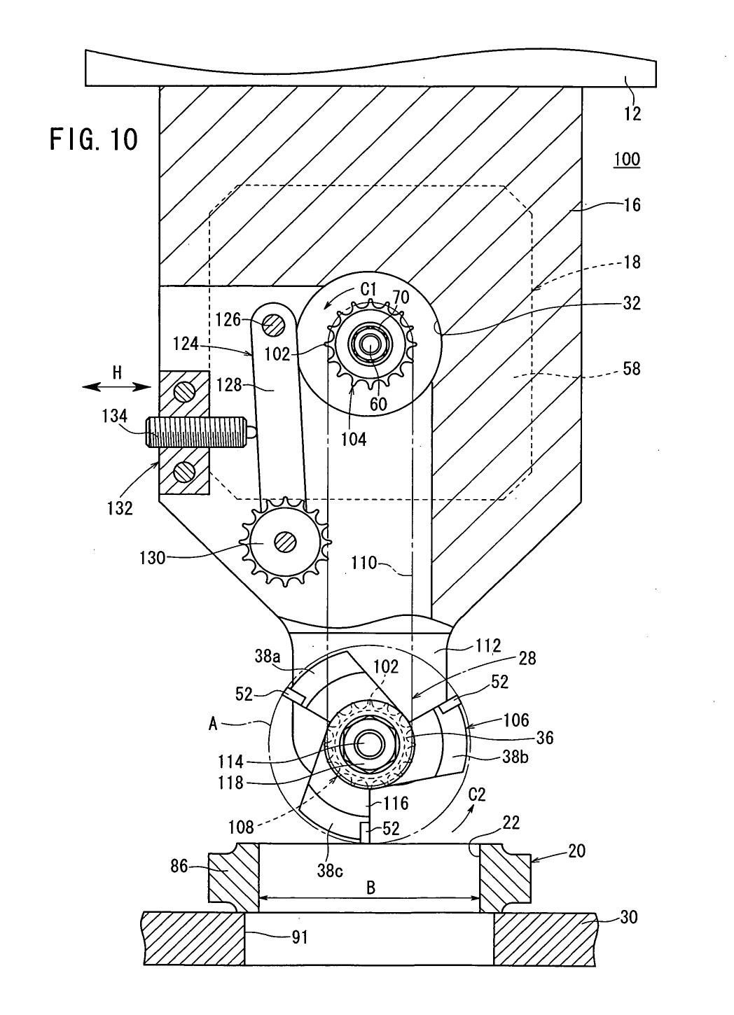

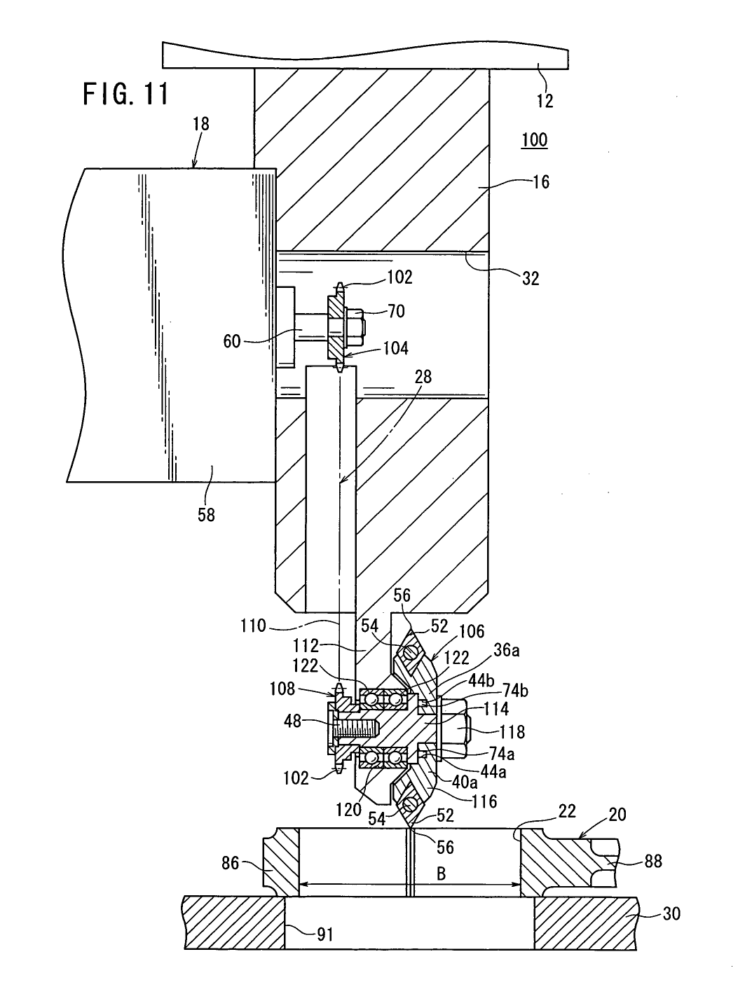

FIGS. 10 through 11 show a machining apparatus 100 for forming cracking slots for a connecting rod according to a second embodiment of the present invention. Those parts of the machining apparatus 100 which are identical to those of the machining apparatus 10 according to the first embodiment are denoted by identical reference characters and will not be described in detail below.

The machining apparatus 100 according to the second embodiment is different from the machining apparatus 10 according to the first embodiment in that it has a first gear 104 integrally mounted on the shaft 60 of the rotary drive source 58 and having a plurality of teeth 102 and a slotting mechanism 106 including a second gear 108 having a plurality of teeth 102, an endless chain 110 is trained around the first and second gears 104, 108 for rotating the slotting mechanism 106 upon energization of the rotary drive source 58, and a spindle 114 is rotatably mounted on a support leg 112 disposed on the lower end of the body 16 and coupled to the second gear 108, the spindle 114 and a cutter 116 being integrally coupled to each other by a lock nut 118 and supported in a cantilevered fashion on the support leg 112.

The support leg 112 extends downwardly from a lower surface of the body 16, and the spindle 114 is rotatably inserted in the lower end of the support leg 112 by a bearing 122 (see FIG. 11) disposed in a through hole 120 defined in the support leg 112. The bearing 122 comprises a plurality of ball bearings such as angular ball bearings or the like each having an annular array of balls, the ball bearings being juxtaposed along the axis of the spindle 114.

As shown in FIG. 11, the second gear 108 is coupled to one end of the spindle 114 by the support bolt 48, and the cutter 116 is coupled to the other end of the spindle 114 by the lock nut 118.

A pair of engaging pins 74a, 74b projects from the spindle 114 toward the cutter 116, having respective ends inserted in respective pin holes 44a, 44b defined in the cutter 116. The engaging pins 74a, 74b are effective to prevent the spindle 114 and the cutter 116 from being rotated relatively to each other, but cause the spindle 114 and the cutter 116 to rotate in unison with each other.

The cutter 116 has a main body 36a having a cavity defined therein to a predetermined depth and extending in a direction away from the support leg 112. The bearing 122 which is supported in the support leg 112 is partly inserted in the cavity in the main body 36a.

As shown in FIG. 10, when the rotary drive source 58 is energized, the first gear 104 coupled to the drive shaft 60 is rotated counterclockwise in the direction indicated by the arrow C1, and transmits its rotary drive power through the chain 110 to the second gear 108. The second gear 108 is rotated to cause the spindle 114 to rotate the cutter 116 counterclockwise in the direction indicated by the arrow C2.

The body 16 houses therein a tension adjusting mechanism 124 for adjusting the tension of the chain 110 that is trained around the first gear 104 and the second gear 108.

The tension adjusting mechanism 124 comprises an arm 128 tiltably supported in the body 16 by a pin 126, a presser gear 130 rotatably mounted on the lower end of the arm 128 and held in mesh with the chain 110, and a pusher 132 mounted in the body 16 in spaced relation to the arm 128. The pusher 132 has a pusher pin 134 displaceably threaded therein and having a tip end normally held in contact with a side surface of the arm 128. When the pusher pin 134 is turned about its own axis and displaced in the direction indicated by the arrow H, which is substantially perpendicular to the arm 128, the arm 128 is tilted about the pin 126.

When the arm 128 is thus tilted, the presser gear 130 mounted on the lower end of the arm 128 changes its pressing force applied to the chain 110. Depending on the tension of the chain 110, the direction in which the pusher pin 134 is turned and the distance that the pusher pin 134 is turned are adjusted to adjust the tension of the chain 110 as desired with the pressing force applied from the presser gear 130.

With the above arrangement, the cutter 116 which is rotated by the rotary drive source 58 for forming cracking slots 24 in the larger end hole 22 in the connecting rod 20 can easily be removed simply by loosening the lock nut 118 threaded over the spindle 114. When the cutting tips 52 are worn out, the cutter 116 can easily be replaced or serviced for maintenance.

The power transmitting structure wherein the chain 110 is trained around the first gear 104 and the second gear 108 and the cantilevered structure wherein the slotting mechanism 106 integrally coupled to the second gear 108 is supported on the support leg 112 are applicable to the machining apparatus 10 according to the first embodiment.

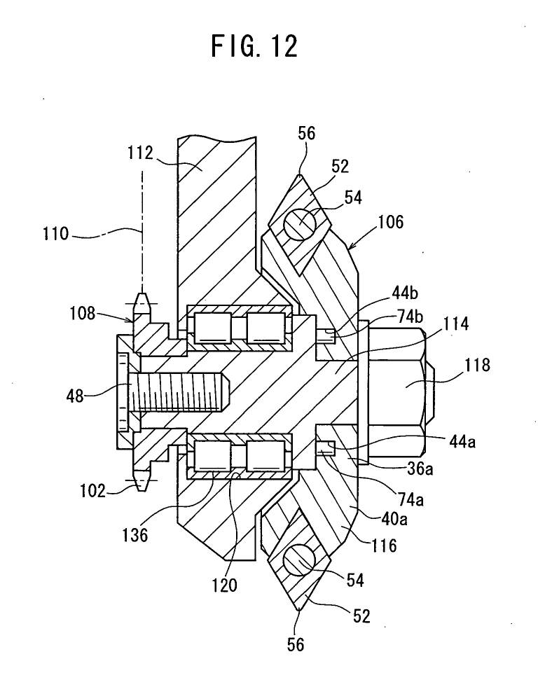

As shown in FIG. 12, the bearing 122 disposed in the support leg 112 may be replaced with a roller bearing 136 having a plurality of cylindrical rollers arrayed in the circumferential direction thereof.

Although certain preferred embodiments of the present invention have been shown and described in detail, it should be understood that various changes and modifications may be made therein without departing from the scope of the appended claims.

1. A machining apparatus for forming a pair of cracking slots in a one-piece connecting rod having a larger end and a smaller end, at respective facing positions on an inner circumferential surface of a larger end hole in said larger end, for fracturing said connecting rod into a rod and a cap, said machining apparatus comprising:
a body;
a rotary drive source coupled to said body and having a drive shaft;
a rotary cutter having a rotary member including a plurality of plates projecting radially outwardly, a plurality of cutting tips disposed on respective peripheral edges of said plates and having respective cutting edges, and a rotational shaft supporting said rotary member and extending substantially parallel to the axis of said connecting rod, said cutting tips being displaceable in a vertical direction substantially perpendicular to the axis of said connecting rod; and
a drive power transmitting mechanism for transmitting rotational drive power from said drive shaft to said rotary cutter;
whereby when said rotary drive source is energized, said drive shaft is rotated to cause said drive power transmitting mechanism to rotate said rotary cutter, and said rotary cutter is displaced toward said larger end hole to cause the cutting edges of said cutting tips to form sharp cracking slots in the inner circumferential surface of the larger end hole.

2. A machining apparatus according to claim 1, wherein said drive power transmitting mechanism comprises a first pulley coupled to said drive shaft, a second pulley rotatably supported on said body and integrally coupled to said rotary cutter, and a drive power transmitting belt trained around said first pulley and said second pulley.

3. A machining apparatus according to claim 1, wherein said drive power transmitting mechanism comprises a first gear coupled to said drive shaft and having a plurality of teeth, a second gear rotatably supported on said body and integrally coupled to said rotary cutter, said second gear having a plurality of teeth, and a chain trained around said first gear and said second gear.

4. A machining apparatus according to claim 1, wherein said cutting edges are disposed on outer circumferential edges of said cutting tips, respectively, and have rounded crests.

5. A machining apparatus according to claim 1, wherein said body has a bearing, said rotational shaft of said rotary cutter being rotatably supported by said bearing.

6. A machining apparatus according to claim 5, wherein said bearing comprises a ball bearing having an annular array of balls.

7. A machining apparatus according to claim 5, wherein said bearing comprises a roller bearing having a plurality of cylindrical elements.

8. A machining apparatus according to claim 2, wherein said body has an opening defined therein and facing toward said first pulley, said opening having a diameter greater than the outside diameter of said first pulley.

9. A machining apparatus according to claim 3, wherein said body has an opening defined therein and facing toward said first gear, said opening having a diameter greater than the outside diameter of said first gear.

10. A machining apparatus according to claim 3, further comprising a tension adjusting mechanism mounted in said body for adjusting the tension of said chain trained around said first gear and said second gear.

11. A machining apparatus according to claim 10, wherein said tension adjusting mechanism comprises:
an arm tiltably supported in said body;
a presser gear rotatably mounted on an end of said arm and held in mesh with said chain; and
a pusher having a pusher pin mounted in said body substantially perpendicularly to said arm, for adjusting a tilted angle of said arm upon axial displacement of said pusher pin.

12. A machining apparatus according to claim 1, wherein said rotary cutter is rotatably supported on one side of said rotary member and an opposite side of said rotary member.

13. A machining apparatus according to claim 12, wherein said body has a pair of support legs, said rotary member being rotatably supported on said support legs by a support bolt extending through said rotary member.

14. A machining apparatus according to claim 13, wherein said rotary member comprises a main body through which said support bolt extends, said plates projecting radially outwardly from said main body.

15. A machining apparatus according to claim 1, wherein said rotary cutter is rotatably supported on either one of opposite sides of said rotary member.

16. A machining apparatus according to claim 1, further comprising a workpiece table having a substantially horizontal surface for placing said connecting rod thereon, said workpiece table having a clearance hole defined therein coaxially with the larger end hole in said connecting rod.

17. A machining apparatus according to claim 1, wherein said cracking slots comprise:
a first slot to be formed when said cutting tips of said rotary cutter are displaced vertically downwardly in said larger end hole while rotating about its own axis; and
a second slot to be formed when said cutting tips of said rotary cutter are displaced substantially horizontally to a surface area of the inner circumferential surface of said larger end hole which faces said first slot and then displaced vertically upwardly, after said first slot is formed.
